(19) United States
(12) Patent Application Publication
(10) Pub. No.: US 2011/0041705 A1
(43) Pub. Date: Feb. 24, 2011

(54) COMPACT SPIRAL-THROUGHFLOW HEATING UNIT WHICH CAN OPERATE AT HIGH PRESSURES

(75) Inventors: Martin Reichl, Michaelbeuren (AT); Andreas Pleschinger, Anthering (AT)

Correspondence Address: SEED INTELLECTUAL PROPERTY LAW GROUP PLLC, 701 FIFTH AVE, SUITE 5400, SEATTLE, WA, 98104, US

(73) Assignee: Bleckmann GmbH & Co. KG, Lamprechtshausen (AT)

(21) Appl. No.: 12/670,392

(22) PCT Filed: Jul. 11, 2008
(86) PCT No.: PCT/EP08/05689

§ 371 Date: Oct. 18, 2010

(30) Foreign Application Priority Data
Jul. 24, 2007 (DE) 10 2007 034 370.3

(51) Int. Cl. A23F 5/04; A23N 12/08

(52) U.S. Cl. 99/323.3

(57) ABSTRACT

A spiral continuous-flow heater unit for electrical appliances for preparing hot beverages including a tubular support having at least one thick-film electrical heating conductor structure on an outer side thereof; a core element within the tubular support having at least one helically extending web on an external surface thereof, wherein two adjacent web edges of the web and the external surface of the core element together form a flow channel that is substantially sealingly closed off in the outward direction with respect to a flow duct by an inner side of the tubular support; and a first and a second end member each having a connector port which communicates with the flow duct, wherein each of the end members is fixedly connected to the core element at their a respective end of the tubular support to form a water-tight and vapor-tight seal between at least the tubular support and end members.

### BACKGROUND

1. Technical Field

The present disclosure relates to a spiral continuous-flow heater unit for electrical appliances for the purpose of preparing hot beverages, which heater unit can be operated at pressures up to 15 bar and more for selectively producing hot water or steam. The disclosure also relates to a compact hydraulic continuous-flow heating system module having a hydraulic spiral continuous-flow heater unit for use in electrical appliances for preparing hot beverages, such as espresso-type coffee machines, or coffee machines for coffee pads.

2. Description of the Related Art

Electrical appliances for and/or with integrated discharge of hot water or steam are found in many household appliances that produce hot water or steam, for example in appliances for preparing hot beverages. The aspects of interest here will be briefly described with reference to prior art coffee and espresso machines that operate according to various different principles.

The best known are coffee machines that work without pressure, in which water is supplied from a reservoir through a heating device, usually an electrically heated pipe, to a filter holder containing a coffee filter with coffee powder therein. Due to the production of steam in the heated pipe, heated water is pressed via a riser pipe to and out of an outlet in order to brew the coffee powder in the coffee filter with the hot water. The brewed coffee flows out of the coffee filter under atmospheric pressure into an appropriate collecting vessel.

In espresso machines, hot water at a temperature around 90° C. is pressed under a much higher pressure of about 15 bar through coffee powder located in a coffee powder receptacle. The cold water is supplied from a water reservoir to an electromotive pump, by means of which the water is then supplied under the required pressure through an electrical heating device, usually a “thermoblock”, to the coffee powder receptacle, for example a brewing group or a portafilter. To generate and maintain the desired high pressure in the region of the coffee powder, the coffee powder receptacle is located in a brewing chamber that is designed as a pressure chamber and which is sealed against atmospheric pressure during the actual brewing operation. The brewed espresso is dispensed from an appropriate outlet of the brewing chamber into a vessel.

Another type of coffee machine that is becoming more and more popular is a cross between a conventional pressure-less coffee machine and an espresso machine. In such a machine, the water for preparing the coffee is firstly fed from the water reservoir into a heatable interim container and then fed as heated water via an electromotive pump under an elevated pressure of 2 to 3 bar to a coffee powder receptacle. Unlike in the espresso machine mentioned above, there is no loose coffee powder in the brewing chamber; instead, the coffee is pre-portioned in the form of a “coffee pad”. The coffee powder is in compressed form and surrounded by filter paper, for example, or encapsulated in aluminum foil and can thus be conveniently inserted in pre-portioned form into the respective receptacle of the brewing chamber. The brewing chamber is usually closed and locked by means of a mechanical cover to provide the sealed pressure chamber into which the hot water is pressed under pressure via a feeder in the cover, and the brewed coffee can be dispensed into a drinking vessel from an appropriate outlet of the brewing chamber.

To prepare the hot water, a heat exchanger in the form of a continuous-flow heater is provided as a heating device in prior art coffee machines that operate with pressure. The heat exchanger generally has an electrical heating element and a water circuit that is thermally connected to said heating element, with the water circulating only when a pump is in operation. The heat exchanger with its electrical heating element, fixing means and electrical safety elements usually forms a sub-assembly called the thermoblock. The thermoblock mostly consists of cast aluminum with a heating element, such as a tubular heating element, that has good thermal conductivity and which is connected to the block, with water channels being provided inside the thermoblock. Although the water can be heated in a very well controlled manner using a thermoblock, with regard to both steam production and to the stability of the brewing temperature, there are substantial disadvantages involved in the complexity of production and in the high thermal mass, i.e., the non-negligible heat capacity in relation to the applied electrical rating of the thermoblock, which results in a long heat-up time or warm-up time until the first hot beverage can be obtained after switching on the machine. On the other hand, the large thermal mass makes it possible to ensure temperature stability or temperature constancy by means of stored heat. That is, the heat-up time can only be achieved by means of suitable oversized heating elements.

European patent EP 1 076 503 B1 shows a water heater for an electrical household appliance, comprising a cylindrical body with a vertical axis, said cylindrical body defining a chamber and having an inlet for feeding water into the chamber and an electrical heating device belonging to the cylindrical body and having a heating element with an electrical resistor printed thereon for heating the water which is fed into the chamber. The body also has an outlet for dispensing hot water, or steam that is formed in the chamber. The heating element is embodied as a printed resistor in the form of a layer or plate that extends over part of the height of the longitudinal wall of the body from substantially the lower end of the body. A thermal protection device is also provided, which can interrupt the power supply to the heating element when the water level in the chamber is below the upper end of the layer, the intention being to protect the arrangement better against damage caused by overheating due to improper operation, such as allowing it to run dry.

### BRIEF SUMMARY

There is a need for a heating system in which the components required for heating water in an appliance for preparing hot beverages, such as a coffee machine, can be combined in a compact module. There is special interest in keeping the time that elapses between switching on the system and being able to obtain the first cup as short as possible using a heating system for the aforementioned purpose.

The spiral continuous-flow heater units and hydraulic continuous-flow heating system modules described herein are particularly well suited for efficiently heating water in a relatively compact form factor or package.

In one form, an embodiment of a spiral continuous-flow heater unit for electrical appliances for preparing hot beverages comprises: a tubular support having at least one thick-film electrical heating conductor structure on its outer side and an outwardly facing flange at each of its two ends, a core element disposed in the tubular support and having at least one helically extending web on the external surface of the core element, wherein two adjacent web edges and the external surface together form a flow channel that is substantially sealingly closed off in the outward direction with respect to a flow duct by the inner side of the tubular support, a first and a second end member each having a connector port which communicates with the flow duct, wherein each of the end members is fixedly connected to the core element at their respective end of the tubular support, and wherein the unit composed of the end members and the core element is composed of at least two parts which engage with each other by means of at least one snap-fit connection and are mechanically biased in such a way that sufficient contact pressure is exerted on seals disposed between the tubular support and the respective end members to ensure that the seals are water-tight and vapor-tight.

In another embodiment, a heating system module is composed of a hydraulic line having a flow meter, a pump, a spiral continuous-flow heater unit and a steam pressure valve as components, wherein the components are each connected via pressure hose connections, and wherein the pump is disposed substantially parallel to the heater unit by means of fixing elements provided on the end members of the spiral continuous-flow heater unit, and the flow meter and the steam pressure valve are each disposed in the region of an end member. The individual components that are required to heat the water in a device for preparing hot beverages, such as a coffee machine, are thus combined in a compact assembly or system module. This permits a space-saving and easily installed heating system module to be provided for manufacturing any design of such hot beverage appliances, with hardly any limitations being imposed on the design of the hot beverage device due to the highly space-saving and room-saving configuration.

In yet another embodiment, a heating system module is composed of a hydraulic line having a flow meter, a pump, a spiral continuous-flow heater unit and a steam pressure valve as components, wherein the components are each connected via pressure hose connections, and wherein the components are fixedly connected to a common support element by means of respective fixing elements, wherein the pump is disposed substantially parallel to the heater unit, and the flow meter and the steam pressure valve are each disposed in the region of an end member. In addition to the aforementioned advantages of the embodiment above, this alternative embodiment offers even greater flexibility in respect of installation in a hot beverage device, with the common support element serving as an “assembly shell” customized for installation.

### BRIEF DESCRIPTION OF THE SEVERAL VIEWS OF THE DRAWINGS

Other advantageous configurations and an embodiment of the present invention shall now be described with reference to the Figures. It should be noted in this regard that the terms “left”, “right”, “bottom” and “top” used in describing the embodiment relate to the drawings oriented in such a way that the reference numerals and figure references are readable in a normal way.

FIG. 1 shows, in a three-dimensional view, an embodiment of a spiral continuous-flow heater unit, in which approximately half of a support tube of the electrical thick-film heater is broken open to provide a view of a core element.

FIG. 2a shows a first longitudinal cross-section through the middle of the spiral continuous-flow heater unit of FIG. 1.

FIG. 2b shows a second longitudinal cross-section through the spiral continuous-flow heater unit, in which the cross-section is taken from 90° further round the longitudinal axis of the heater unit from the view shown in FIG. 2a.

FIG. 3a shows a three-dimensional view of the core element with the water-guiding channel of the spiral continuous-flow heater unit of FIG. 1.

FIG. 3b shows a longitudinal cross-section through the middle of the core element of FIG. 3a.

FIG. 4a shows a three-dimensional view of the tubular support of the spiral continuous-flow heater unit of FIG. 1.

FIG. 4b shows a longitudinal cross-section through the middle of the tubular support of FIG. 4a.

FIG. 5a shows a three-dimensional view of one of the two covers, on its own, with a connector port for the spiral continuous-flow heater unit of FIG. 1.

FIG. 5b shows a plan view of the cover in FIG. 5a, from the outside.

FIG. 5c shows a longitudinal cross-section of the cover in FIGS. 5a and 5b, along cross-sectional plane CC*.

FIG. 6 shows an embodiment of a hydraulic line in which all the system components for a complete heating system are mounted directly on a continuous-flow heater.

FIG. 7 shows another embodiment of a hydraulic line in which all the system components for a complete heating system are not mounted directly on a continuous-flow heater, but with an assembly shell as a support that is adapted to the specific installation situation for the respective use.

FIG. 8 shows a block diagram with the system components of the hydraulic line in FIGS. 6 and 7.

### DETAILED DESCRIPTION

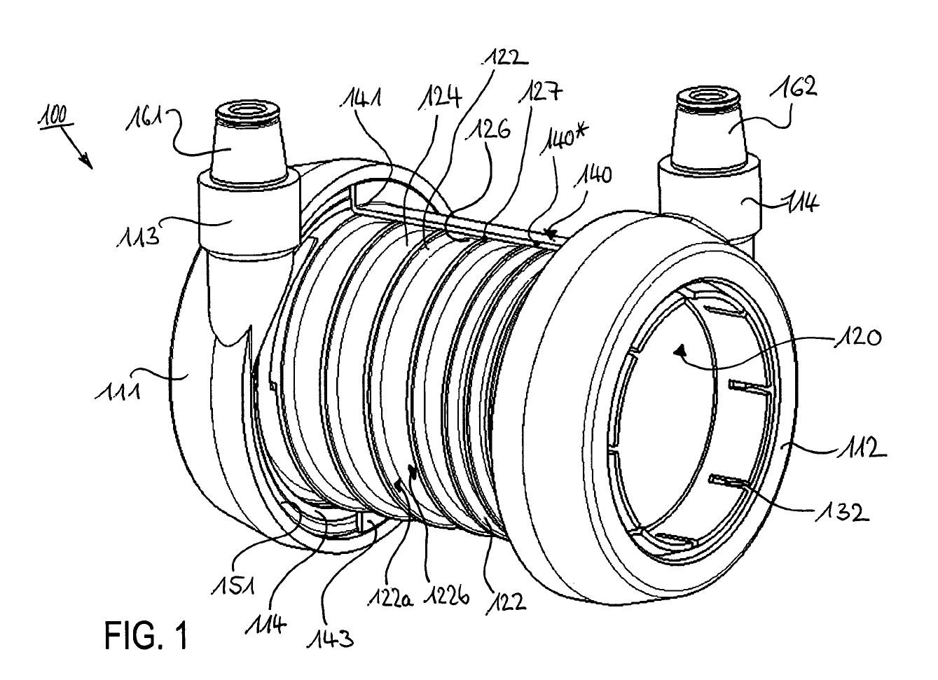

FIG. 1 shows a three-dimensional view of a spiral continuous-flow heater unit 100 according to an embodiment of the invention, comprising two covers or end members 111, 112 consisting of a heat-resistant plastic suitable, in particular for exposure to steam, an example being PPA (polyphtalamide). Other examples are PPE (polyphenylene ether), PPS (polyphenylene sulphide) and PTFE. End members 111, 112 are each pressed at one end of a core element 120 by means of a snap-fit connection 131, 132 against a tubular support 140 arranged on core element 120, or clamp said tubular element between them and thus fix the entire arrangement in position.

Tubular core element 120 is likewise made of a heat-resistant plastic suitable, in particular, for steam, such as the aforementioned PPA, PPE, PPS or PTFE, and has a helically extending web 122, in which two adjacent edges 122a, 122b of the web 122 form a water-guiding channel 124 that likewise extends helically around core element 120. It is preferred that the end members 111, 112 and the core element 120 are each produced integrally as plastic injection molded parts.

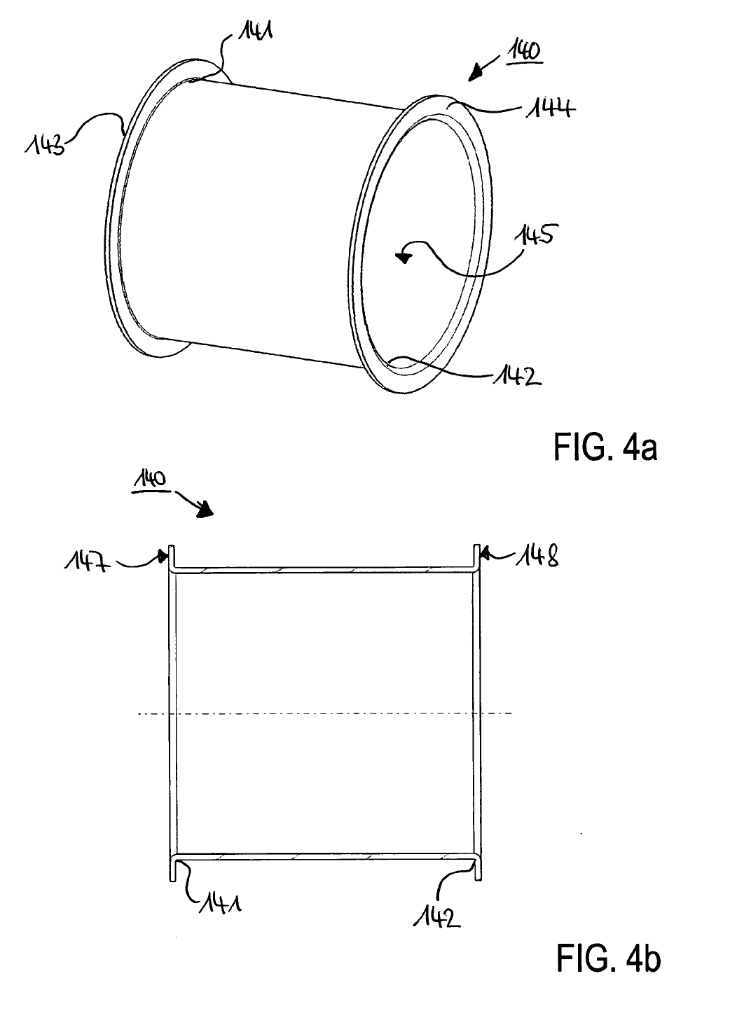

It can be seen from the cutaway edge 140* of tubular support 140 that the water-guiding channel 124 is sealed off from the outside by the inner surface 145 of tubular support 140 to form a flow duct 126. It should be noted here that a pressure fit at the contact surfaces 127 between the web 122 and the inner surface 145 of support tube 140 is sufficient for the heater unit 100 to function, since the flow resistance of one cycle, i.e., of a 360° turn of flow duct 126 is substantially less than the flow resistance of a gap between web 122 and the inner surface 145 (see FIG. 4a) of support tube 140.

The tubular support 140 has an outwardly facing flange 143, 144 (concealed in FIG. 1) at each of its two ends 141, 142 (likewise concealed in FIG. 1). On the left-hand cover or end member 111 in FIG. 1, it can be seen that the flange face facing in the direction of cover 111 lies in a circumferential recess 114 of end member 111 with an O-ring seal 151located between the flange face 116 of cover 111 and the flange face of support tube 140, said seal 151 being compressed by the arrangement biased by means of the snap-fit connection in such a way that heater unit 100 is sealed against hot water and against steam at operating pressures of at least 15 bar and more.

Each of the covers 111, 112 has a connector port 113, 114 which is designed to accommodate a hydraulic plug connection 161, 162, in order to permit a high-pressure connection to other system components by means of a matching high-pressure tube. Since such hydraulic connection techniques or hose connection techniques and high-pressure tubes are known to a person skilled in the art of hot-water appliances that operate under pressure, and are not essential for understanding the present invention, they are not described here in any further detail.

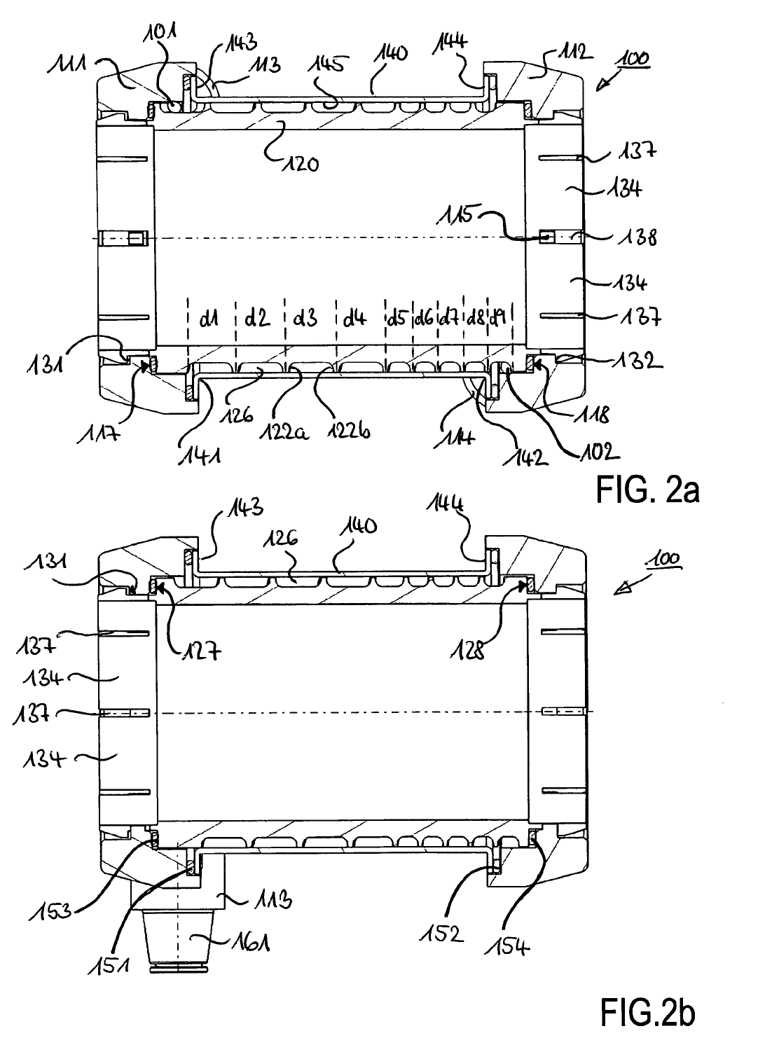

FIGS. 2a and 2b each show a longitudinal cross-section through the middle of the spiral continuous-flow heater unit 100 of FIG. 1, wherein the cross-section in FIG. 2b is through a plane that is rotated 90° from the cross-sectional plane in FIG. 2a.

It can be seen from the cross-sectional views that the pitch of spiral web 122 decreases in the direction of one end of heater unit 100, i.e., has a smaller pitch. As a result, the width (d1, d2, . . . , d9) of water-guiding channel 124 and of the cross-section of flow duct 126 decreases in the direction of end member 112, which inevitably means that the flow speed of the heated water in the heater unit increases towards the outlet due to the continuous volumetric flow rate.

Outlet 102 of heater unit 100 is therefore located at end member 112, where flow duct 126 has the smallest cross-section of flow, and outlet entry 101 of heater unit 100 is located accordingly at the other end member 111.

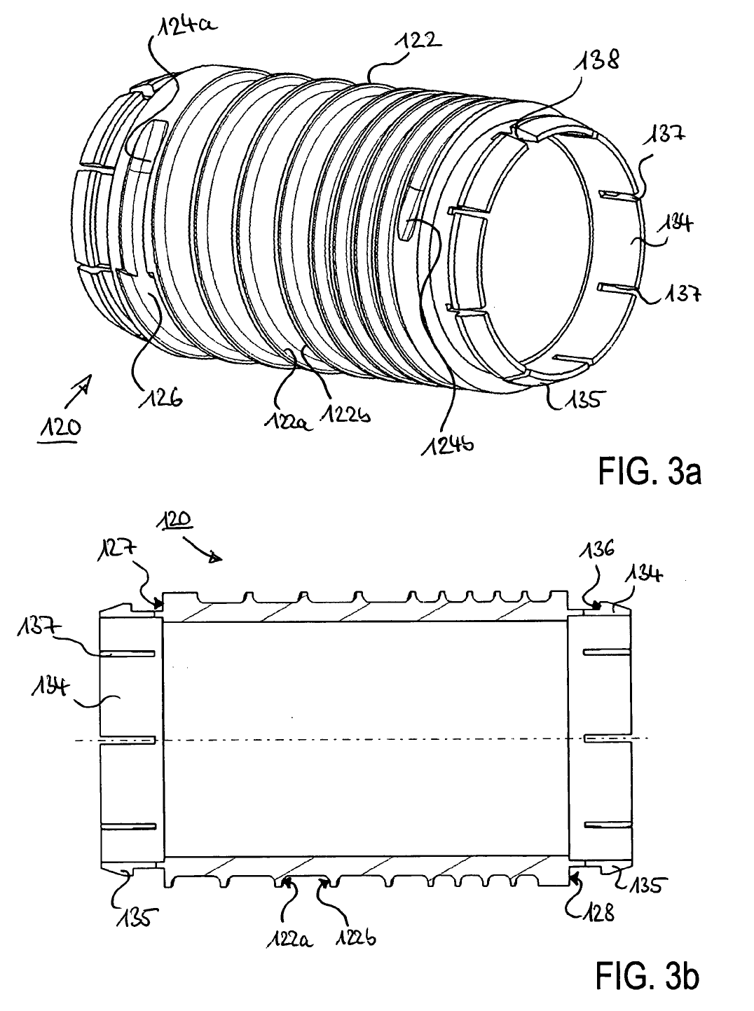

FIG. 3a shows a three-dimensional view of the core element 120, with flow channels 124 of the heater unit 100 of FIG. 1, and FIG. 3b shows a longitudinal cross-section through the middle of the core element 120 of FIG. 3a.

At the left-hand end of core element 120 is the initial region of water-guiding channel 124, which is significantly narrower in this initial region 124a than the actual flow duct 126 that immediately follows, which is formed by the web 122 extending helically around core element 120 and which has its largest cross-section there.

Water-guiding channel 124 is formed through circumferential web 122 along the outer surface of core element 120 by two opposite web edges 122a and 122b as left-hand and right-hand boundaries, with a decreasing pitch towards the end opposite the initial region 124a of the water-guiding channel 124. At the right-hand outlet end of core element 120, the water-guiding channel 124 and flow duct 126 end in an end region 124b, where flow duct 126 communicates with the inlet or outlet, respectively, via holes 101a, 102a provided accordingly, after the flow duct is joined to the annular covers or end members 111, 112 shown in FIG. 1.

At the respective ends of core element 120, flexible tongues with catch hooks 134, extending along the circumference of the end of core element 120, are arranged at regular distances apart. As can be seen better from FIG. 3b, the catch hooks 134 act as a spring element, i.e., the material or wall thickness in relation to the longitudinal axis of core element 120 tapers in an arrow-like or ramp-like manner towards the end of core element 120 such that the catch hooks 134 may be urged radially inward when acted upon.

When joining core element 120 and an end member 111, 112 such as the one shown in FIG. 1, the edges of the catch hook 134 serve, as a slantingly extending, ramp-like sliding contact and pressure surface 135, to press away the respective catch hooks 134 radially inwards. In the intended end position, the catch hook 134 can then catch with its circumferential shoulder or edge 136 behind a circumferential edge provided in the respective cover or end member, or latch or snap into the edge embodied as undercutting, in such a way that the parts latched and snapped into are permanently fixed in position.

Disposed between the individual catch hooks 134 there are regular recesses 138 that are substantially spaced apart from each other in such a way that the individual catch hooks 134 have sufficient flexibility for the bending away movement during the snap-in operation as described above, yet have sufficient stiffness to ensure enough stability for the permanent connection and clamping of the arrangement when the snap-fit connection has been established.

At least one of the recesses 138 (see FIGS. 3a and FIG. 2a) has a different shape compared to the other recesses, and in particular a different width that is matched exactly to the width of a guide lug 115 provided on the respective cover or end member 111, 112, in order to allow end members 111, 112 to be mounted with a predetermined orientation to the core piece, in particular during automatic production. The aim of the predetermined orientation is that holes 101a, 102a in inlet connector port 110 and outlet connector port 102 lead correctly into the respective starting region and end region, respectively, of water-guiding channel 126.

FIG. 4a shows a three-dimensional view of the tubular support 140 of the spiral continuous-flow heater unit 100 in FIG. 1, and FIG. 4b shows a longitudinal cross-section through the middle of the tubular support 140 in FIG. 4a.

As already mentioned, tubular support 140 has a first end 141 and a second end 142, at each of which a circumferential, outwardly facing flange 143, 144 is respectively provided. In order to produce a water-tight and/or vapor-tight interface between tubular support 140 and the body of heater unit 100 comprising end members 111, 112 and core element 120, flanges 143, 144 at either end of the tubular support each have an annular circumferential flange face 147, 148 facing substantially away from the respective end of the tubular support.

Tubular support 140 is preferably made of a ferritic stainless steel, but in one advantageous embodiment may also be produced from two different metals that are mechanically joined to each by means of plating, for example.

It is likewise preferred that the inner surface 145 of tubular support 120, which during normal operation of heater unit 100 is in contact with the water to be heated, is made of a corrosion-resistant metal. Of course, it is also possible to provide inner surface 145 with an additional functional layer that prevents the adhesion of lime. Layers which reduce the free surface energy, such as PTFE coatings based on LXE (liquid wax ester) systems, have specifically proved advantageous here.

Tubular support 140 carries as a heating element at least one electrical heating conductor layer realized using thick-film techniques, and serves simultaneously for transferring heat from the at least one heating element to the water to be heated in flow duct 126 inside tubular support 140. The support tube 140 preferably consists of a ferritic stainless steel, with the inner surface 145, as the side facing the water as the medium to be heated (i.e., the medium side), preferably having a lime-repellent and/or corrosion-resistant coating.

The at least one heating conductor layer preferably has a thickness in the range from 5 to 150 μm. The heating conductor layer preferably consists of one of the following materials, or a selected combination thereof: nickel-based, iron-based, aluminum-based, copper-based, cobalt-based, molybdenum-based and titanium-based metals, and combination thereof. Cermets and ceramics, such as barium titanate, are also conceivable, and a particularly preferred embodiment is one in which NiCr 8020 and kanthal are used.

In one particular embodiment, the support tube 140 consists of at least one first and one second metal layer forming a composite. The first inner metal layer is in contact with the water during normal operation and consists of a metal that is largely corrosion-resistant against water, especially steam. The second, outer metal layer consists of aluminum or of an alloy of aluminum with copper, magnesium, manganese, silicon, iron, titanium, beryllium, chromium, zinc, zirconium and/or molybdenum and carries the electrical heating system as functional layers. What is preferred is a permanent bond between the first metal layer and the second metal layer by means of rolling or roll plating.

The thick-film structure may have a layer that electrically insulates it against the support tube 140, in the region of the heating conductor layer that conducts current and voltage during operation, or of the conductor structures that will be described later. The electrical insulating layer has a thickness in the range between 0.1 and 0.3 mm.

The thick-film structure may also have one or more additional functional layers that are designed, for example, as conductive strip layers for electrical signals and which are connected to circuit elements for protecting, monitoring, controlling or regulating the heater unit or for performing a combination of said functions. One of the additional functional layers may be disposed in the same layer defined by the heating conductor layer and/or may also be disposed above or below the layer defined by the heating conductor layer. In this way, for example, conductive strips carrying electrical signals for temperature monitoring and/or temperature measurement can contact corresponding sensor components, such as an NTC resistor, preferably using SMD technology, that are disposed on or near a heating conductor strip of the heating conductor layer.

Said conducting strip layers have a thickness in a range between 5 and 150 μm. The conducting strip layers preferably consist of one of the following materials, or of a selected combination thereof: copper-based and silver-based metals, or the like, with CuNi10 and CuNiZn being especially preferred.

Reference is also made at this point to one particular embodiment of the electrical heater unit having an electrical heating conductor in the form of the thick-film heater for protecting the heating element and the surroundings during both proper and improper operation, particularly with regard to the risk of fire, but also with regard to mechanical damage to the heating element due to overheating.

For this reason, the respective momentary resistance of the at least one electrical resistor heating element of the thick-film heater is detected by an appropriately adapted controller in a special configuration of a system for protecting and controlling the continuous-flow heater. Changes over time in the resistance of the at least one electrical resistor heating element are also determined, and the power of the heating system is controlled on the basis of the current change in resistance over time.

As a particularly simple form of protection against the heating system drying out or running empty, the change in resistance of the at least one electrical resistor heating element over time is substantially determined after a predetermined system-dependent time constant or start-up time after the electrical heating element has been switched-on. That is to say, during the start-up period there is no control of the electrical heating element as yet, in the sense of operational control and/or protection, although it is essentially possible to detect changes in resistance over time as soon as the system is switched on.

What is decisive for the duration of the predetermined start-up time for the respective heating system is the start-up behavior of the heating elements and its thermal masses. After the start-up time or delay time, the heating system must be or should be at the correct operating temperature for normal operation; the proper operating state can be recognized by the fact that the change in electrical resistance over time has a much lower gradient compared to when there is a malfunction, such as running on an empty water tank. After this delay, therefore, it is possible to respond accordingly, i.e., to control the system, by performing a simple analysis of the current gradient of the resistance over time (dR(t)/dt). Attention is drawn to the fact that assessing the current change in resistance over time as too high or too low is essentially the same as comparing the current value with a predetermined or system-dependent value. The assessment carried out in order to control the heating system accordingly may be as follows, for example. If, after the preset or predetermined delay time or start-up time, there is no water in the heating system, the resistance continues to increase sharply (dR(t)/dt is high), and the heating element is accordingly switched off in order to prevent damage by overheating. If, however, there is enough water in the heating system, the resistance increases more slowly (dR(t)/dt is low) or remains almost constant, and the heating system can continue to output heat to the water in the system in order to produce hot water or steam.

Continuous-flow heating can thus be protected in a relatively simple manner against damage caused by excessive heat conductor temperatures, due to improper operation such as operation without water. More specifically, it is not necessary to define an absolute or relative resistance value as the switching threshold, which usually does not permit reliable temperature control or temperature monitoring on the basis of permitted scattering of values. In other words, the above protective measure is totally independent of the temperature thresholds that depend on material variations in the heating conductor.

In one embodiment of the heater unit, the temperature of the medium can be measured alternatively or additionally with an integrated temperature sensor. This may be embodied as a soldered NTC resistor, for example. If the temperature sensor is disposed as high as possible when the heater unit is installed vertically, i.e., when the longitudinal axis of the core element of the heater unit is arranged perpendicularly to the base of the entire system, it is also possible to detect any improper operating state, such as the heater unit running dry (i.e., having no water).

In another embodiment of the heater unit, the functional layers and/or the insulating layer(s) are impregnated with one of the following materials, or a selected combination thereof, to render them hydrophobic: siloxane, silicone oil, nanocoating, aluminum oxide suspension, boehmite, or similar. Siloxane is used particularly preferably for impregnation.

In one embodiment of the heating system, a cover layer is provided at least for the functional layers of the heating system. The at least one cover layer preferably has a thickness in the range between 10 and 200 μm. It is particularly preferred that the thickness of the cover layer be 20 μm. The at least one cover layer preferably consists of one of the following materials, or a selected combination thereof: polyether ether ketone (PEEK), polytetrafluoroethylene (PTFE), polyphenylene sulphide (PPS), silicone, silicone polyester, epoxide, PI or similar, with silicone being particularly preferred.

With regard to production of the thick-film heating system, it should be noted that the layers of the electrical heating system are produced on the outside of the support tube by a layer forming process, preferably by a thermal injection molding process such as an arc-spraying method, for example.

An electrical insulating layer produced by physical vapor deposition, anodizing, hard anodizing or oxidizing, for example, is provided at least in the region of the functional layers of the thick-film structure. The at least one heating conductor layer and any additional conducting strip layers are produced thereon, preferably as functional layers, by means of a thermal injection molding method such as atmospheric plasma spraying and arc spraying. During production, the one functional layer or plurality of functional layers are deposited on the entire surface by layer-forming processes, with the conductor strips being subsequently structured in the respective functional layer by a removal process. Removal by laser or water jet, or a combination of such methods, is particularly preferred for this purpose.

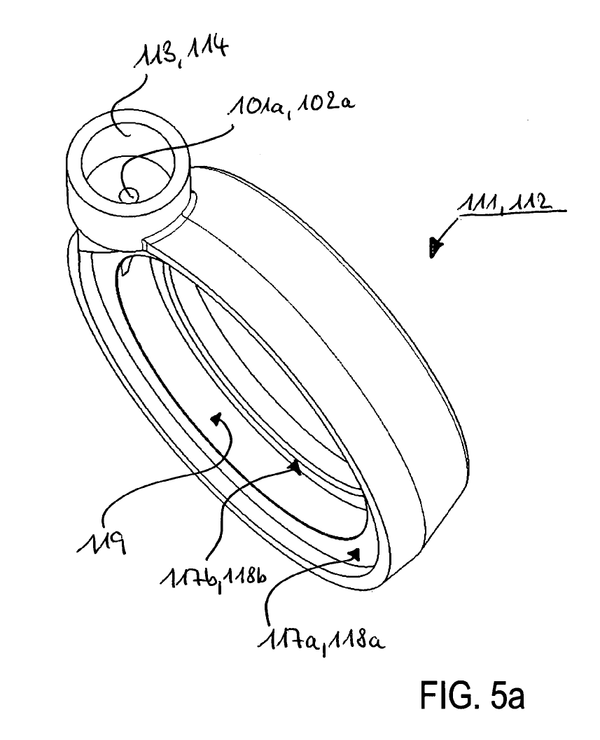

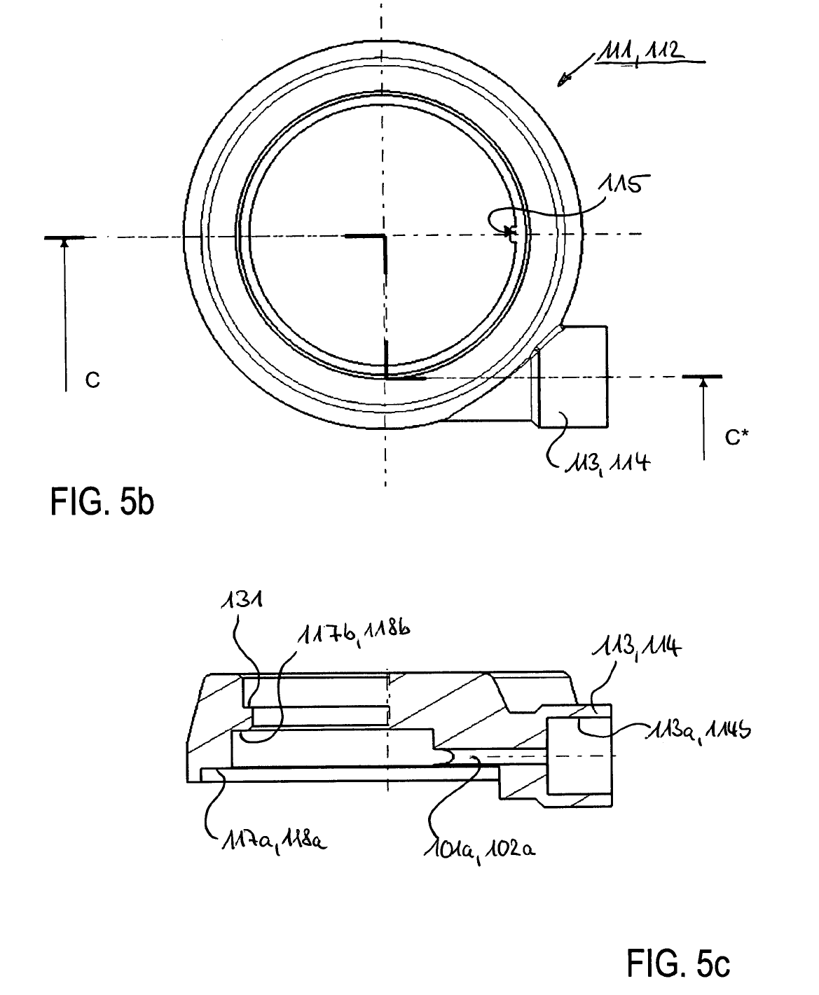

FIG. 5a shows a three-dimensional view of one of the two covers or end members 111, 112 shown in FIG. 1, comprising a connector receiver 113, 114 for the spiral continuous-flow unit 100 of FIG. 1, with FIG. 5b showing a plan view of the cover in FIG. 5a and FIG. 5c showing a longitudinal cross-section along cutting plane CC* through the cover or end member 111, 112 in FIGS. 5a and 5b.

Inside the annular cover or end member 111, 112 there is a circumferential sealing face 117a and 118a, which in the assembled state of heater unit 100 forms a water-tight and vapor-impermeable seal in conjunction with the respective flange 143, 144 of tubular support 140, with an O-ring seal inserted as a sealing element 151, 152 therebetween.

The inside of the annular cover also has an inner face 119 in the form of a cylinder jacket, the diameter of which is substantially identical to the inner diameter of tubular support 140 and the outer diameter of core element 120, measured from the outermost point of the outer circumferential web 122 on one side to the outermost point of web 122 on the opposite side.

The inner face 119 of the cover or end member 111, 112, in relation to core element 120, is also defined on the inner side by sealing face 117a, 118a and on the other side by another sealing face 117b, 118b, which extends substantially perpendicularly to inner surface 119 and parallel to sealing face 117a, 118a over the entire circumference of the annular cover or end member 111, 112.

The second, likewise annular sealing face 117b, 118b forms another water-tight and vapor-tight seal together with a front face 127, 128 of core element 120, by means of O-ring seals 153, 154 disposed therebetween as sealing means. As a result, the flow duct 126 extending helically inside heater unit 100 is sealed off externally at both ends of heater unit 100 against any escape of water or steam by means of a seal disposed between support tube 140 and an end member 111, 112 and by means of a seal disposed between one front face 127, 128 of core element 120 and the respective cover or end member 111, 112.

FIG. 5b is a plan view of the cover or end member 111, 112, in which the annular configuration and the tangential orientation of the connector receiver 113, 114 can be seen. In FIG. 5b one can also see the guide lug 115 disposed on the inner surface of the cover or end member 111, 112, which guide lug 115 ensures predetermined and correctly oriented installation by means of the matching recess 138 on core element 120, as shown in FIG. 2a.

FIG. 5c shows a cross-sectional view along cutting plane CC*, the course of which is defined in FIG. 5b and which essentially shows the structure of an annular cover or end member 111, 112 in somewhat more detail. The design of the connector receiver 113, 114 can be seen particularly well, into which the respective hydraulic plug connections for high-pressure hose connections can be inserted, and the through hole 101a, 102a for hydraulic communication between a connected hose connection and flow duct 126, the through hole 101a, 102a leading substantially tangentially into flow duct 126 when heater unit 100 is assembled.

The following remarks need to made at this point regarding embodiments of a spiral continuous-flow heater unit 100, as discussed in detail above. The body formed by core element 120 and the two end members 111, 112 can essentially be embodied as two parts as well, with the core element as described being produced with one end member to form one unit, as a result of which a sealing interface between the core element and an end member is essentially omitted. Of course, the subdivision of the body formed by the two end members and the core element, as required for producibility reasons, can also be carried out elsewhere than described here.

To produce the snap-fit connection, it is also possible to provide the flexible tongues with the catch hooks for the snap-fit connection on one or both end members, and to provide corresponding circumferential edges on the inner surface of the core element for engagement of the catch hooks. With knowledge of the present invention, a person skilled in the art will immediately recognize numerous possible modifications of the arrangement described, but which do not deviate from principles of the present invention.

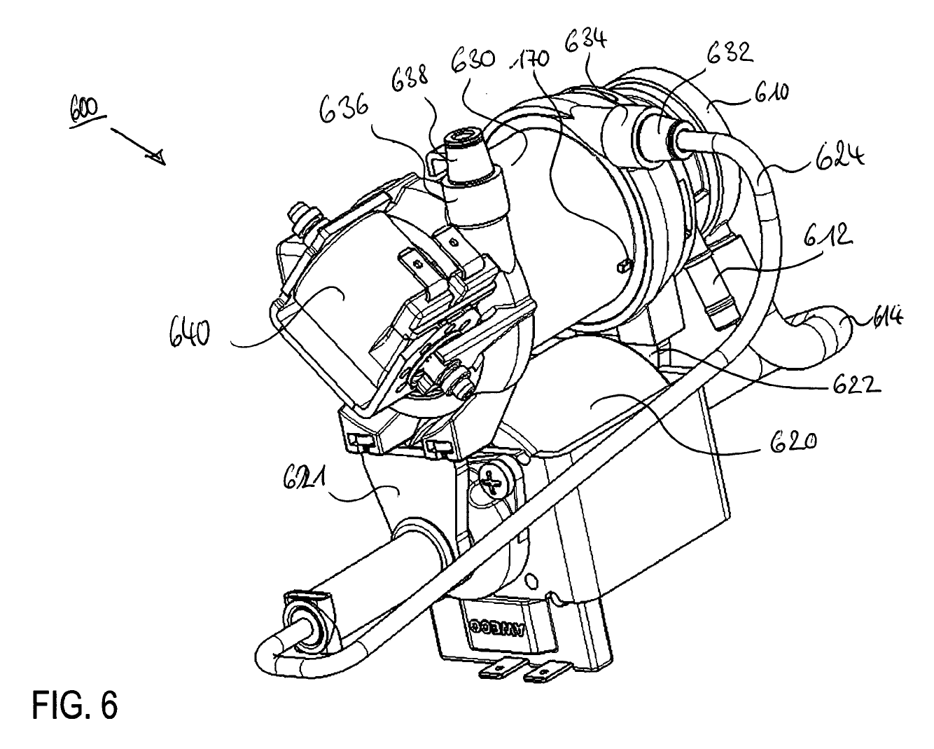

FIG. 6 shows an embodiment of a hydraulic line in which all the system components for a complete heating system module 600 are mounted directly on a spiral continuous-flow heater unit according to various embodiments of the invention.

The hydraulic line is composed of the following components, which are named in the following according to the direction of flow. The first component after a water reservoir or any other water connection (not shown) is a flow meter 610 with a suitable connection member 612 for a tube. By means of the flow meter, the required amount of water can be measured when preparing a hot beverage, although the flow meter can also be used to protect the heater unit in a simple manner against running dry, because when the flow meter shows that there is no throughput, this indicates a lack of water or that a pump is defective, and hence that the heater unit can be automatically switched off.

After flow meter 610, the water is fed via a connecting tube 614 to an electromechanical pump 620 which is designed for generating the required pressure of 2.5 to 3 bar for use in coffee pad coffee machines, or for 13 to 15 bar for use in espresso machines. The water is fed under pressure from pump 620 via a hose connection 624 suitable for high-pressure operation, for example a Teflon tube, to the spiral continuous-flow heater unit 630. The hose is typically connected to the supply connection 634 by a prior art hydraulic plug connection 632.

In the spiral continuous-flow heater unit 630, the water is heated to the required temperature, i.e., depending on the specific application to approximately 90° C. to 130° C., and at the end opposite supply connection 634 is fed via a suitable discharge connection 636 to a corresponding module of the hot beverage device. Said module may be a brewing group or a portafilter of an espresso machine or a carrier for coffee pads in a coffee pad coffee machine or a device for foaming milk or a dispensing point or dispensing device for hot water or steam. Finally, an electrically controlled steam expansion valve 640 is also integrated, by means of which the pressure in the system can be reduced or removed after preparing a hot beverage or taking steam or hot water.

The system components referred to above are all mounted directly onto the spiral continuous-flow heater unit 630 of the invention, which is slightly modified in relation to the embodiment illustrated in FIGS. 1 to 5.

In order to dampen or decouple the effects of mechanical vibrations of pump 620 during operation, the pump is fixed to the modified end members of the spiral continuous-flow heater unit 630 of the invention, for example with holders 621, 622 made of a material that dampens vibrations, such as an elastomer or some other suitable elastic material.

Heating system module 600 is used to brew hot water and to produce steam in coffee machines, and is conceived first and foremost for installation in espresso machines; the high pressures in excess of 15 bar, as required in espresso machine, are not a problem in this regard due to the structure of the spiral continuous-flow heater unit according to various embodiments of the present invention. One particular advantage of the arrangement is the compact, easily assembled structure and the possibility of providing manufacturers of appliances with a complete, space-saving system module from a single source.

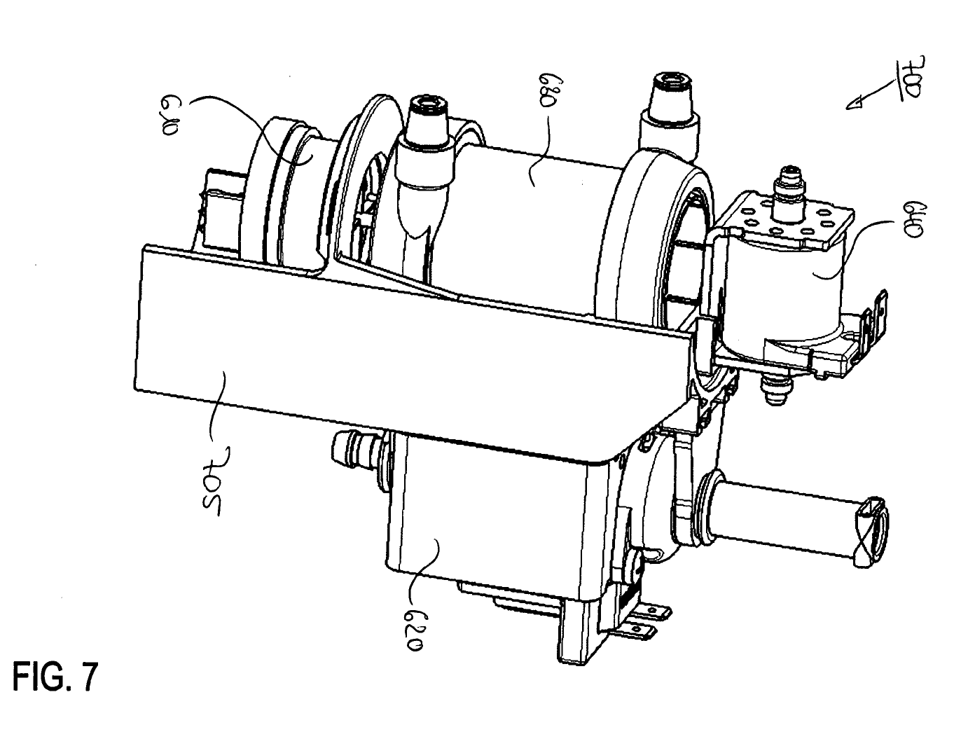

FIG. 7 shows another embodiment of a hydraulic line, in which all the system components for the complete heating system module 700 are not mounted directly onto a spiral continuous-flow heater unit, but are each mounted instead onto an assembly shell 705 as support or holder. The assembly shell 705 can be adapted to the specific installation situation for the respective application. The variant shown in FIG. 7 otherwise performs the same function as the one shown in FIG. 6 and therefore does not require any renewed description. A particular advantage of the system shown in FIG. 7 is the space-saving and easily installed structure, as well as the individual adaptability of the assembly shell as an interface to the appliance in which the module is to be installed.

In connection with systems shown in FIGS. 6 and 7, reference is also made to an embodiment of the invention, in which space available inside the spiral continuous-flow heater is put to use by arranging components such as the flow meter and/or the steam expansion valve and/or the pump inside the flow core.

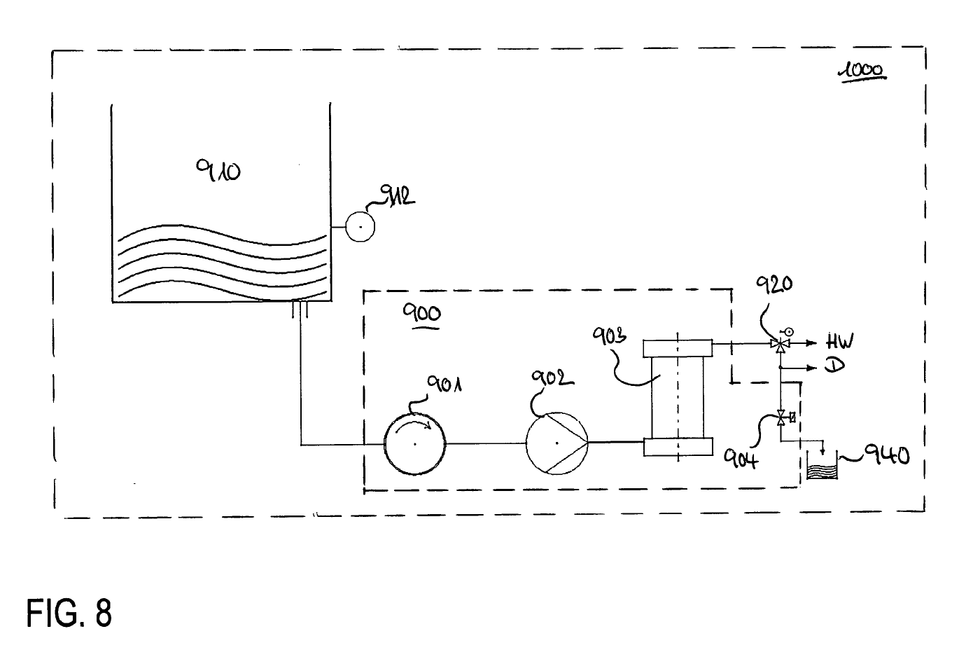

FIG. 8 shows a schematic overview of the system of a hot-water device 1000 comprising a heating system module 900 according to various embodiments of the present invention. A water reservoir 910 is connected to the flow meter of heating system module 900 comprising flow meter 901, pump 902, heater unit 903 and steam pressure valve 904, with a water-level indicator 912 being provided on water reservoir 910 as a further protective measure against running dry. At the outlet of heating system module 900 there is a control valve 920 by means of which the hot beverage appliance controls the feeding of hot water HW produced or steam D produced to the respective point of use, depending on the selection made by the user. Finally, the steam expansion valve 904 connected to the steam circuit and the respective collecting container 940 are also suggested.

Various changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A spiral continuous-flow heater unit for electrical appliances for preparing hot beverages, comprising:
a tubular support having at least one thick-film electrical heating conductor structure on an outer side thereof and an outwardly facing flange at each of a first and a second end of the tubular support;
a core element inside the tubular support the core element having at least one helically extending web on an external surface thereof, wherein two adjacent web edges of the helically extending web and the external surface of the core element together form a flow channel that is substantially sealingly closed off in the outward direction with respect to a flow duct by an inner side of the tubular support; and
a first and a second end member each having a connector port which communicates with the flow duct the end members each connected at a respective one of the first and second ends of the tubular support to the core element, and wherein at least one of the end members and the core element engage each other by at least one snap-fit connection and are configured to exert sufficient contact pressure on a seal arranged between the tubular support and the end member to ensure that the seal is water-tight and vapor-tight.

2. The spiral continuous-flow heater unit of claim 1, wherein a pitch of the helically extending web decreases in the direction of the connector port which serves as an outlet, such that the width of the flow channel and thus the cross-section of the flow duct decreases towards the outlet.

3. The spiral continuous-flow heater unit of claim 1 wherein the at least one snap-fit connection is between a first end of the core element and the end member disposed thereon.

4. The spiral continuous-flow heater unit of claim 1 wherein at least one snap-fit connection is provided between each of a first and a second end of the core element and the respective end member disposed thereon.

5. The spiral continuous-flow heater unit of claim 1, further comprising:
at least one seal an end face of one faces of the end members and an opposing end face of the core element.

6. The spiral continuous-flow heater unit of claim 1, wherein the core element is hollow, such that the heater unit is a tube which is open at at least one end.

7. The spiral continuous-flow heater unit of claim 1, further comprising:
a respective hydraulic connection member at each of the connector ports, and wherein a through hole is provided in each of the connector ports at a respective end of the heater unit so that the flow duct communicates with each respective hydraulic connection member.

8. The spiral continuous-flow heater unit of claim 7, wherein the through holes extend into the flow duct substantially tangentially in relation to the tubular support.

9. The spiral continuous-flow heater unit of claim 1, further comprising:
a respective sealing element disposed between a surface of a respective one of the flanges of the tubular support and a corresponding contact surface of a respective one of the end members.

10. The spiral continuous-flow heater unit of claim 1, wherein the tubular support consists of a ferritic stainless steel.

11. The spiral continuous-flow heater unit of claim 1, wherein the inner surface of the tubular support is provided with at least one of a lime-repellent and/or a corrosion-resistant coating.

12. The spiral continuous-flow heater unit of claim 1, further comprising:
an electrically insulating layer between the material of the tubular support and the electrical heating conductor structure.

13. The spiral continuous-flow heater unit of claim 1, further comprising:
one or more additional functional layers on the tubular support embodied as conductive strip layers for electrical signals which are connected to at least one component for protecting, monitoring, controlling or regulating the heater unit.

14. The spiral continuous-flow heater unit of claim 13 wherein at least one of the additional functional layer is disposed in a layer defined by the heating conductor structure.

15. The spiral continuous-flow heater unit of claim 1, further comprising:
a temperature detection element for protecting against overheating.

16. The spiral continuous-flow heater unit of claim 1, further comprising:
a temperature sensor in the form of an NTC resistor soldered onto the tubular support to measure water temperature.

17. The spiral continuous-flow heater unit of claim 16 wherein the temperature sensor is disposed substantially above the flow duct and close to an outlet of the heater unit.

18. The spiral continuous-flow heater unit of claim 17 wherein the temperature sensor is disposed high on the tubular support in relation to a vertically mounted position of the heater unit.

19. The spiral continuous-flow heater unit of claim 1 wherein the at least one thick-film electrical heating conductor structure is electrically coupled to a plug connection on the tubular support.

20. The spiral continuous-flow heater unit of claim 13 wherein the conductive strip layers for electrical signals of the at least one component for protecting, monitoring, controlling or regulating the heater unit and the at least one thick-film electrical heating conductor structure are each electrically coupled to a plug connection on the tubular support.

21. A heating system module, comprising:
a hydraulic line comprising a flow meter;
a pump;
a steam pressure valve; and
a spiral continuous-flow heater unit, the pump disposed substantially parallel to the spiral continuous-flow heater unit by fixing elements provided on end members of the spiral continuous-flow heater unit, and the flow meter and the steam pressure valve arc each disposed in the region of one of the end members of the spiral continuous-flow heater unit.

22. A heating system module, comprising:
a hydraulic line comprising a flow meter;
a pump;
a steam pressure valve; and
a spiral continuous-flow heater unit, wherein the flow meter, the pump, the steam pressure valve and the spiral continuous-flow heater unit fixedly connected to a common support element via respective fixing elements, and wherein the pump is disposed substantially parallel to the heater unit, and the flow meter and the steam pressure valve are each disposed in the region of one of end members of the heater unit.

23. The heating system module of claim 21 wherein at least one of the flow meter and the steam pressure valve are at least partially disposed inside a core element of the spiral continuous-flow heater unit.

24. The heating system module of claim 21 wherein the pump is disposed inside a core element of the spiral continuous-flow heater unit.
